(19) United States
(12) Patent Application Publication
(10) Pub. No.: US 2009/0278863 A1
(43) Pub. Date: Nov. 12, 2009

(54) PLASMA DISPLAY PANEL DRIVE METHOD AND PLASMA DISPLAY DEVICE

(75) Inventor: Yutaka Yoshihama, Osaka (JP)

Correspondence Address: RATNERPRESTIA, P.O. BOX 980, VALLEY FORGE, PA, 19482, US

(73) Assignee: PANASONIC CORPORATION, Osaka (JP)

(21) Appl. No.: 12/088,784

(22) PCT Filed: Feb. 13, 2007
(86) PCT No.: PCT/JP2007/052474

§ 371 Date: Mar. 31, 2008

(30) Foreign Application Priority Data
Feb. 14, 2006 (JP) 2006-036325

(51) Int. Cl. G09G 3/28; G09G 5/10

(52) U.S. Cl. 345/690; 345/63

(57) ABSTRACT

A panel drive method and a plasma display device which increase the luminance of a panel and enable further reduction of power consumption are provided with the following configuration. One field is composed of a plurality of subfields including a address period during which a address discharge is selectively induced in discharge cells and a sustain period during which sustain pulses the number of which corresponds to the luminance weight are applied to induce sustain discharges in the discharge cells where the address discharges are induced. The plasma display device has a sustain pulse generating circuit composed of a power recovering circuit for inducing the rise and fall of each sustain pulse by resonating the inter-electrode capacity of a display electrode pair with an inductor and a clamp section for clamping the voltage of the sustain pulses to a predetermined voltage. The repetition period of the sustain pulse can be set according to the average luminance level of the image signal.

### TECHNICAL FIELD

The present invention relates to a plasma display panel drive method and plasma display device for use in wall-mounted television sets or large monitors.

### BACKGROUND ART

In a typical AC planar discharge type panel as a plasma display panel (hereinafter referred to as “panel”), a plurality of discharge cells are formed between a front substrate and a rear substrate disposed to oppose each other. A plurality of display electrode pairs each composed of a scanning electrode and a sustain electrode are formed in parallel on the front substrate and dielectric layer and protective layer are formed so as to cover those display electrodes. In the rear substrate, a plurality of parallel data electrodes are formed on the rear substrate glass substrate and the dielectric layer is formed so as to cover those and further a plurality of barrier ribs are formed in parallel to the data electrodes thereon. Phosphor layer is formed on the surface of the dielectric layer and on the side face of the barrier rib. The front substrate and the rear substrate are disposed to oppose each other such that the display electrode pair and the data electrode intersect three-dimensionally and are sealed together and its internal discharge space is filled with discharge gas containing 5% xenon in partial pressure ratio. The discharge cells are formed at a portion in which the display electrode pair and the data electrode oppose. Ultraviolet ray is generated in each discharge cell of the panel having such a configuration by gas discharge, and phosphors of respective colors, red (R), green (G) and blue (B) are excited to emit light by this ultraviolet ray so as to perform color display.

As a method for driving the panel, subfield method, that is, a method for gradation display by dividing a 1-field period into plural subfields and then combining the subfields from which to emit light is generally used. Each subfield has initializing period, address period and sustain period and generates initializing discharge in the initializing period so as to form wall charge necessary for subsequent address operation on each electrode. In the address period, address discharge is generated selectively in a discharge cell on which to display so as to form wall charge. In the sustain period, sustain pulse is applied alternately to the display electrode pair composed of the scanning electrode and sustain electrode, sustain discharge is generated by the discharge cell in which the address discharge is induced so as to make the phosphor layer of a corresponding discharge cell to emit light to perform image representation.

Various power consumption reduction skills for reducing power consumption have been proposed for such a plasma display unit. Particularly as one of the art for reducing power consumption in the sustain period, there has been proposed a so-called electric power recovering circuit in which with attention paid to a fact that each display electrode pair is a capacitive load having an inter-electrode capacity of the display electrode pair, LC resonance between an inductor and the inter-electrode capacity is induced using a resonant circuit containing the inductor as its component to recover charges accumulated in the inter-electrode capacity into an electric power recovering capacitor and recycles the recovered charges for driving the display electrode pair (for example, see patent document 1).

In the subfield method also, there has been proposed a new driving method in which initializing discharge is performed selectively to a discharge cell in which the sustain discharge is executed further by performing the initializing discharge using a voltage waveform which changes mildly so as to improve contrast ratio by reducing light emission not related to gradation display as much as possible (see, for example patent document 2).

In recent years, the panel has been of higher definition and has been larger and additionally, various high luminance technologies have been introduced thereby increasing power consumption, and consequently, a further reduction in power consumption has been requested.

[Patent document 1] Examined Japanese Patent Publication No. 7-109542
[Patent document 2] Unexamined Japanese Patent Publication No. 2000-242224

### DISCLOSURE OF THE INVENTION

The panel drive method and plasma display device of the present invention provide a panel drive method and plasma display device which increase the luminance of the panel and enable reduction of power consumption.

The present invention concerns a drive method of a panel including a plurality of discharge cells each having a display electrode pair composed of a scanning electrode and a sustain electrode. One field is composed of a plurality of subfields including a address period during which a address discharge is selectively induced in discharge cells and a sustain period during which sustain pulses the number of which corresponds to the luminance weight are applied to induce sustain discharges in the discharge cells where the address discharges are induced. Further, the plasma display device according to the present invention has a sustain pulse generating circuit composed of a power recovering section for inducing the rise and fall of each sustain pulse by resonating the inter-electrode capacity of a display electrode pair with an inductor and a clamp section for clamping the voltage of the sustain pulses to a predetermined voltage. Further, the plasma display device according to the present invention sets a repetition period of the sustain pulse according to the average luminance level of the image signal. It is therefore possible to reduce the power consumption.

According to the plasma display panel drive method of the present invention, preferably, the repetition period of the sustain pulse in a subfield having maximum luminance weight is shortened gradually as the average luminance level of the image signal decreases.

According to the plasma display panel drive method of the present invention, preferably, an overlapping period during which the rise time of the sustain pulse to be applied to one of the display electrode pair and the rise time of the sustain pulse to be applied to the other of the display electrode pair overlap each other is provided and the overlapping period of at least a subfield having maximum luminance weight is prolonged gradually as the average luminance level decrease.

According to the plasma display panel drive method of the present invention, preferably, a time double the rise time of the sustain pulse is set to the duration time of the sustain pulse or more. The duration time mentioned here refers to a time in which the voltage of the sustain pulse is clamped to a predetermined voltage.

The plasma display device of the present invention comprises a panel including a plurality of discharge cells each having a display electrode pair composed of a scanning electrode and a sustain electrode, an average luminance level detecting circuit for detecting an average luminance level of an image signal and a sustain pulse generating circuit for generating sustain discharge by applying sustain pulse to each of the display electrode pair. The sustain pulse generating circuit includes a power recovering section for inducing the rise and fall of each sustain pulse by resonating the inter-electrode capacity of a display electrode pair with an inductor and a clamp section for clamping the voltage of the sustain pulses to a predetermined voltage, and sets the repetition period of the sustain pulse according to the average luminance level of the image signal.

### BRIEF DESCRIPTION OF THE DRAWINGS

FIG. 1 is a disassembly perspective view showing the configuration of a panel according to an embodiment of the present invention.

FIG. 2 is an electrode arrangement diagram of the panel according to the embodiment of the present invention.

FIG. 3 is a circuit block diagram of a plasma display device according to the embodiment of the present invention.

FIG. 4 is a waveform diagram of drive voltage to be applied to each electrode of the panel according to the embodiment of the present invention.

FIG. 5 is a diagram showing a subfield configuration according to the embodiment of the present invention.

FIG. 6 is a circuit diagram of a sustain pulse generating circuit according to the embodiment of the present invention.

FIG. 7 is a timing chart showing an operation of the sustain pulse generating circuit according to the embodiment of the present invention.

FIG. 8A is a diagram showing a relationship between rise time of sustain pulse and reactive power of the sustain pulse generating circuit according to the embodiment of the present invention.

FIG. 8B is a diagram showing a relationship between rise time of the sustain pulse and luminous efficiency according to the embodiment of the present invention.

FIG. 9 is a diagram showing a relationship among an applied voltage to the sustain electrode in initializing period, erase phase difference and rise time at final sustain pulse according to the embodiment of the present invention.

FIG. 10 is a diagram showing a relationship between rise time of a second last sustain pulse and an applied voltage to the sustain electrode in initializing period according to the embodiment of the present invention.

FIG. 11 is a diagram showing a relationship between lighting ratio and lighting voltage of the embodiment of the present invention with the sustain cycle as a parameter.

FIG. 12 is a diagram showing a relationship between APL of a plasma display device and a shape of the sustain pulse according to the embodiment of the present invention.

FIG. 13 is a diagram showing a relationship among sustain cycle, sustain time and write voltage of the present invention.

FIG. 14 is a waveform diagram of a drive voltage applied to each electrode of the panel of other embodiment of the present invention.

### REFERENCE MARKS IN THE DRAWINGS

1 plasma display device

10 panel

21 front substrate (made of glass)

22 scanning electrode

23 sustain electrode

24, 33 dielectric layer

25 protective layer

28 display electrode pair

31 rear substrate

32 data electrode

34 barrier rib

35 phosphor layer

51 image signal processing circuit

52 data electrode drive circuit

53 scanning electrode drive circuit

54 sustain electrode drive circuit

55 timing generating circuit

58 APL detecting circuit

100, 200 sustain pulse generating circuit

110, 210 power recovering circuit

120, 220 (voltage) clamp portion

C10, C20 capacitor (for power recovery)

Cp inter-electrode capacity

Q11, Q12, Q13, Q14, Q21, Q22, Q23, Q24, Q28, Q29 switching device

D11, D12, D21, D22 diode (for backflow prevention)

L11, L12, L21, L22 inductor

### DETAILED DESCRIPTION OF THE PREFERRED EMBODIMENTS

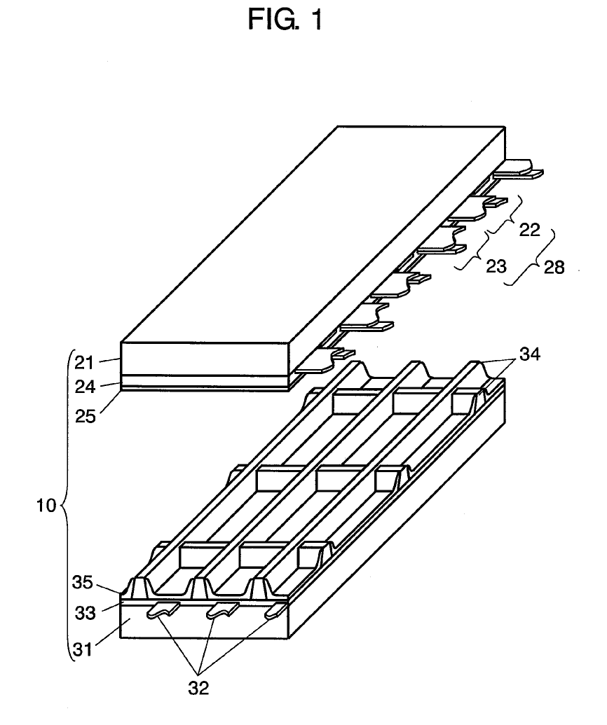

FIG. 1 is a disassembly perspective view showing the configuration of a panel 10 according to the embodiment of the present invention. A plurality of display electrode pairs 28 composed of scanning electrode 22 and sustain electrode 23 are formed on front substrate 21 made of glass. Dielectric layer 24 is formed so as to cover scanning electrodes 22 and sustain electrodes 23 and protective layer 25 is formed on dielectric layer 24. A plurality of data electrodes 32 are formed on rear substrate 31 and dielectric layer 33 is formed so as to cover data electrodes 32 and then, mesh-like barrier ribs 34 are formed thereon. Phosphor layers 35 for emitting lights of red (R), green (G) and blue (B) are provided on the side face of barrier rib 34 and the dielectric layer 33.

Display electrode pairs 28 and data electrodes 32 are disposed such that they intersect and oppose across a fine discharge space on front substrate 21 and rear substrate 31 while their outer peripheral portions are sealed with sealing material. The discharge space is filled with for example, mixture gas of neon and xenon. According to this embodiment, discharge gas adjusted to 10% in partial pressure of xenon is used to improve luminance. The discharge space is divided to a plurality of sections by barrier ribs 34 and the discharge cell is formed at a portion in which display electrode pair 28 and data electrode 32 intersect. When these discharge cells are discharged to emit light, an image is displayed.

In the meantime, the configuration of the panel is not restricted to the above-described one but for example, the panel may be provided with stripe-like barrier ribs.

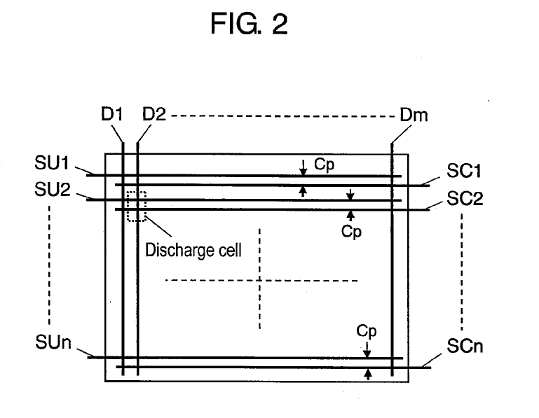

FIG. 2 is an electrode arrangement diagram of panel 10 according to the embodiment of the present invention. n scanning electrodes SC1-SCn (scanning electrodes 22 in FIG. 1) and n sustain electrodes SU1-SUn (sustain electrode 23 in FIG. 1) are arranged in row direction of the panel 10. m data electrodes D1-Dm (data electrode 32 in FIG. 1) are arranged in column direction. Then, discharge cell is formed at a portion where a pair of the scanning electrode SCi (i=1−n) and the sustain electrode SUi and a data electrode Dj (j=1−m) intersect and m×n discharge cells are formed in the discharge space. Because the scanning electrode SCi and the sustain electrode SUi are formed in pair in parallel to each other as shown in FIG. 1 and FIG. 2, a large inter-electrode capacity Cp exists between the scanning electrode SC1-SCn and the sustain electrode SU1-SUn.

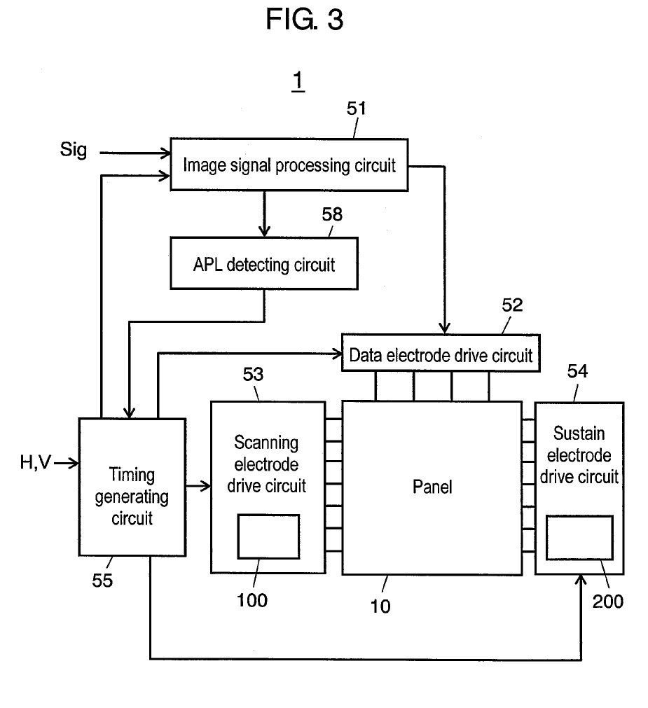

FIG. 3 is a block diagram of plasma display device 1 according to the embodiment of the present invention. The plasma display device 1 comprises panel 10, image signal processing circuit 51, data electrode drive circuit 52, scanning electrode drive circuit 53, sustain electrode drive circuit 54, timing generating circuit 55, APL detecting circuit 58 and a power circuit (not shown) for supplying necessary power to each circuit block.

Image signal processing circuit 51 converts inputted image signal Sig to image data indicating light emission/no light emission in each subfield. Data electrode drive circuit 52 converts image data of each subfield to signal corresponding to respective data electrodes D1-Dm and drives respective data electrodes D1-Dm. APL detecting circuit 58 detects average luminance level (hereinafter referred to as “APL”) of image signal Sig. More specifically, APL is detected by using a generally known method, for example, by accumulating the luminance of the image signal throughout a field or a frame period.

Timing generating circuit 55 generates various kinds of timing signals for controlling an operation of each circuit block based on the APL detected by horizontal synchronous signal H, vertical synchronous signal V and APL detecting circuit 58. Scanning electrode drive circuit 53 includes pulse generating circuit 100 for generating sustain pulse to be applied to scanning electrodes SC1-SCn in a sustain period and drives respective scanning electrodes SC1-SCn based on a timing signal.

Sustain electrode drive circuit 54 includes a circuit for applying a voltage Ve1 to sustain electrodes SU1-SUn in the initializing period and sustain pulse generating circuit 200 for generating a sustain pulse to be applied to sustain electrodes SU1-SUn in the sustain period and drives sustain electrodes SU1-SUn based on a timing signal.

Next, a drive voltage waveform for driving panel 10 and its operation will be described. The plasma display device 1 indicates gradation according to the subfield method, namely, by dividing a field period to plural subfields and controlling light emission/non-light emission of each discharge cell for each subfield. Each subfield period has an initializing period, address period and sustain period. In the initializing period, initializing discharge is generated so as to form wall charge necessary for subsequent address discharge on each electrode. The initializing operation at this time includes initializing operation for generating initializing discharge on all discharge cells (hereinafter referred to as “all-cell initializing operation” and initializing operation for generating the initializing discharge at a discharge cell in which the sustain discharge has been done (hereinafter referred to as “selective initializing operation”). In the address period, address discharge is generated selectively with a discharge cell in which light is to be emitted so as to form the wall charge. Then, in the sustain period, a quantity of sustain pulses proportional to luminance weight is applied alternately to the display electrode pair so that the sustain discharge is generated in the discharge cell in which the address discharge has been generated, so as to emit light. The constant of proportion at this time is called luminance magnification. In the meantime, the detail of the subfield configuration will be described later and drive voltage waveform in the subfield and its operation will be described.

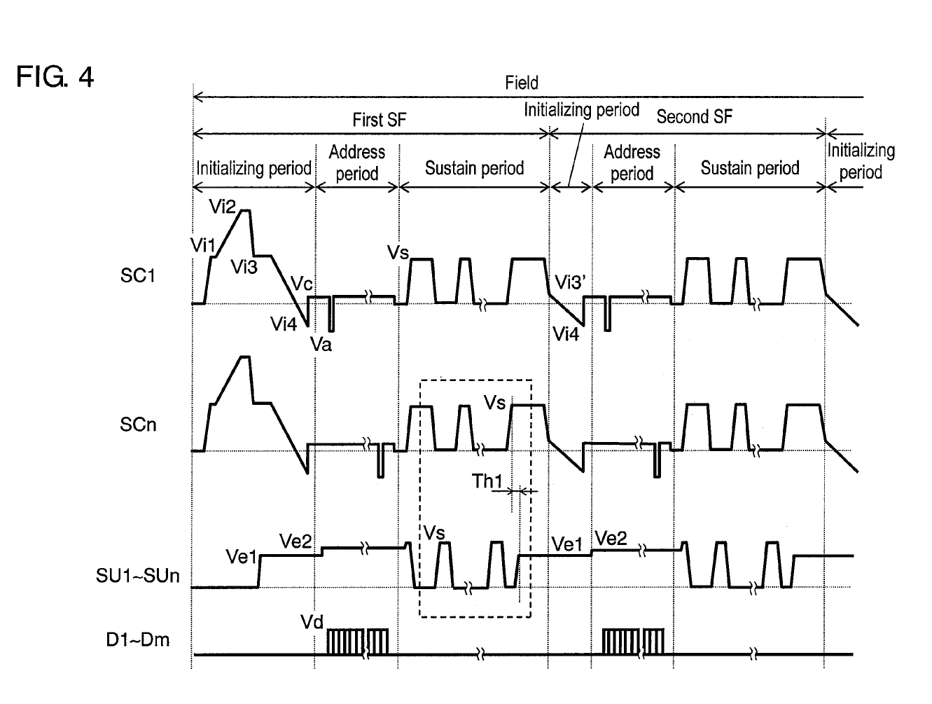

FIG. 4 is a drive voltage waveform to be applied to each electrode of panel 10 according to the embodiment of the present invention. FIG. 4 shows a subfield for performing all-cell initializing operation and a subfield for performing the selective initializing operation.

First, the subfield in which the all-cell initializing operation is to be performed will be explained.

In front half of the initializing period, 0V is applied to data electrodes D1-Dm and sustain electrodes SU1-SUn and ramp waveform voltage (hereinafter referred to “ramp voltage”) which rises mildly from a voltage Vi1, which is below the breakdown voltage with respect to sustain electrodes SU1-SUn, toward a voltage Vi2 over a breakdown voltage is applied to scanning electrodes SC1-SCn. While the ramp voltage is rising, minute initializing discharge occurs between scanning electrodes SC1-SCn, sustain electrodes SU1-SUn and data electrodes D1-Dm. Negative wall voltage is accumulated on top of scanning electrodes SC1-SCn and positive wall voltage is accumulated on top of data electrodes D1-Dm and sustain electrode SU1-SUn. The wall voltage on top of the electrode mentioned here indicates a voltage generated from the wall charge accumulated on dielectric layer, protective layer and phosphor layer and the like covering the electrode.

In rear half of the initializing period, positive voltage Ve1 is applied to sustain electrodes SU1-SUn and ramp voltage Vi3 which lowers mildly from a voltage Vi3 below breakdown voltage with respect to sustain electrodes SU1-SUn toward a voltage Vi4 over breakdown voltage is applied to scanning electrodes SC1-SCn. In this period, minute initializing discharge occurs among scanning electrodes SC1-SCn, sustain electrodes SU1-SUn and data electrodes D1-Dm. Negative wall voltage on top of the scanning electrodes SC1-SCn and positive wall voltage on top of sustain electrodes SU1-SUn are weakened and the positive wall voltage on top of data electrodes D1-Dm is adjusted to a value appropriate to address operation. As a result, all-cell initializing operation which performs initializing discharge on all discharge cells is terminated.

In the subsequent address period, a voltage Ve2 is applied to sustain electrodes SU1-SUn and a voltage Vc is applied to scanning electrodes SC1-SCn. Next, negative scanning pulse voltage Va is applied to scanning electrode SC1 on a first row and positive write pulse voltage Vd is applied to data electrode Dk (k=1−m) of a discharge cell to be made to emit light on the first row of data electrodes D1-Dm. A voltage difference at an intersecting portion between the top of data electrode Dk and top of scanning electrode SC1 is a difference of external applied voltages (Vd−Va) plus a difference between the wall voltage on data electrode Dk and wall voltage on scanning electrode SC1, exceeding breakdown voltage. Then, address discharge occurs between data electrode Dk and scanning electrode SC1 and between sustain electrode SU1 and scanning electrode SC1, so that positive wall voltage is accumulated on scanning electrode SC1 and negative wall voltage is accumulated on sustain electrode SU1 while negative wall voltage is accumulated on data electrode Dk. By inducing address discharge on a discharge cell to be made to emit light on the first row, address operation for accumulating wall voltage on each electrode is performed. On the other hand, because the voltage at the intersecting portion between data electrodes D1-Dm supplied with no write pulse voltage Vd and scanning electrode SC1 does not exceed breakdown voltage thereby generating no address discharge. The above-described address operation is continued until discharge cell of n row is reached and then, the address period is terminated.

In subsequent sustain period, a power recovering circuit is driven to reduce power consumption and the detail of the drive voltage waveform will be described. The sustain operation in the sustain period will be outlined. First, positive sustain pulse voltage Vs is applied to scanning electrodes SC-SCn and a voltage 0V is applied to sustain electrodes SU1-SUn. Then, in a discharge cell in which address discharge occurs in a previous address period, a difference of voltage between the top of scanning electrode SCi and the top of sustain electrode SUi is sustain pulse voltage Vs plus a difference between the wall voltage on scanning electrode SCi and the wall voltage on sustain electrode SUi, thereby exceeding a breakdown voltage. Then, sustain discharge is generated between scanning electrode SCi and sustain electrode SUi and phosphor layer 35 emits light due to ultraviolet ray generated at this time. Then, negative wall voltage is accumulated on scanning electrode SCi and positive wall voltage is accumulated on sustain electrode SUi. Further, positive voltage is accumulated on data electrode Dk. No sustain discharge is generated in a discharge cell in which no address discharge is generated in address period and a wall voltage when the initializing period is terminated is maintained.

Subsequently, a voltage 0V is applied to scanning electrodes SC1-SCn and a sustain pulse voltage Vs is applied to sustain electrodes SU1-SUn. Then, in the discharge cell in which the sustain discharge is generated, a difference in voltage between the top of sustain electrode SUi and the top of scanning electrode SCi exceeds breakdown voltage so that sustain discharge is generated between sustain electrode SUi and scanning electrode SCi and negative wall voltage is accumulated on sustain electrode SUi while positive wall voltage is accumulated on scanning electrode SCi. Likewise, a quantity of sustain pulses produced by multiplying luminance weight with luminance magnification is applied to scanning electrodes SC1-SCn and sustain electrodes SU1-SUn alternately and by providing a difference of potential between the display electrode pair and the electrode, sustain discharge is continued in the discharge cell in which address discharge has been generated in the address period.

Narrow pulse-like voltage difference is applied between scanning electrodes SC1-SCn and sustain electrodes SU1-SUn at an end of sustain period so as to erase part or all of the wall voltage on scanning electrode SCi and sustain electrode SUi with positive wall voltage remaining on top of data electrode Dk. More specifically, after sustain electrodes SU1-SUn are returned to 0V temporarily, sustain pulse voltage Vs is applied to scanning electrodes SC1-SCn. Consequently, sustain discharge is generated between sustain electrode SUi of a discharge cell in which sustain discharge is generated and scanning electrode SCi. A voltage Ve1 is applied to sustain electrodes SU1-SUn before this discharge is ended, that is, while charged particles generated by discharge remain sufficiently in discharge space. Consequently, the difference of voltage (Vs·Ve1) between sustain electrode SUi and scanning electrode SCi is weakened to about (Vs−Ve1). Consequently, the wall voltage between the top of scanning electrodes SC1-SCn and top of sustain electrodes SU1-SUn is weakened to a difference of voltages (Vs−Ve1) applied between respective electrodes. Hereinafter this discharge is called “erase discharge”.

After voltage Vs for generating final sustain discharge, namely, erase discharge is applied to scanning electrodes SC1-SCn, voltage Ve1 for relaxing a difference of potential between the electrodes of the display electrode pair is applied to sustain electrodes SU1-SUn after a predetermined time interval (hereinafter referred to as “erase phase difference Th1”). Consequently, sustain operation in sustain period is terminated.

Next, an operation of the subfield which performs the selective initializing operation will be described.

In the initializing period in which the selective initializing is performed, a voltage Ve1 is applied to sustain electrodes SU1-SUn and 0V is applied to data electrodes D1-Dm and ramp voltage which lowers mildly from a voltage Vi3′ toward a voltage Vi4 is applied to scanning electrodes SC1-SCn. Consequently, minute initializing discharge is generated on a discharge cell in which sustain discharge is generated in the sustain period of a previous subfield so that the wall voltage on sustain electrode SUi is weakened on scanning electrode SCi. Because sufficient positive wall voltage is accumulated on the data electrode Dk by sustain discharge just before, an excess portion of this wall voltage is discharged so as to adjust to a wall voltage suitable for address operation. On the other hand, a discharge cell in which sustain discharge is not generated in a previous subfield is never discharged but the wall discharge at a time when the initializing period of the previous subfield is terminated is maintained as it is. Such a selective initializing operation is an operation which performs selective initializing discharge on a discharge cell in which sustain operation is performed in the sustain period of the subfield just before.

Because the operation in the subsequent address period is the same as the operation of the address period of a subfield which performs all of the cell initialization, description thereof is omitted. An operation of subsequent sustain period is the same except the quantity of sustain pulses.

Next, the configuration of the subfield will be described.

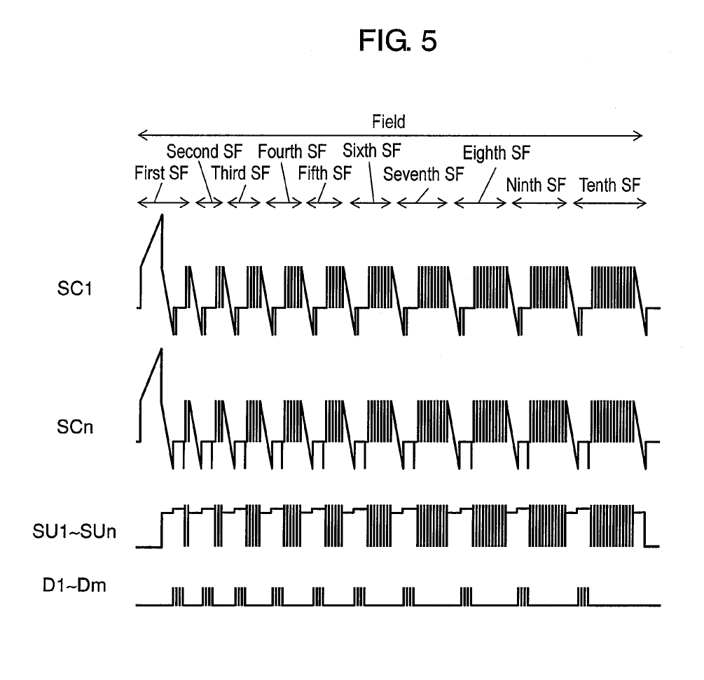

FIG. 5 is a diagram showing the configuration of the subfield according to the embodiment of the present invention. In this embodiment, a field is divided to 10 subfields (first SF, second SF, . . . tenth SF). Each subfield has luminance weight of for example, (1, 2, 3, 6, 11, 18, 30, 44, 60, 80). In the initializing period of the first SF, the all-cell initializing operation is performed and in the initializing period of the second SF—tenth SF, the selective initializing operation is performed. In the sustain period of each subfield, a quantity of sustain pulses obtained by multiplying the luminance weigh of each subfield with a predetermined luminance magnification is applied to each of the display electrode pair.

However, the present invention is not restricted to the above-described value in terms of the quantity of the subfields and luminance weight of each subfield. Further, the subfield may be switched based on an image signal or the like.

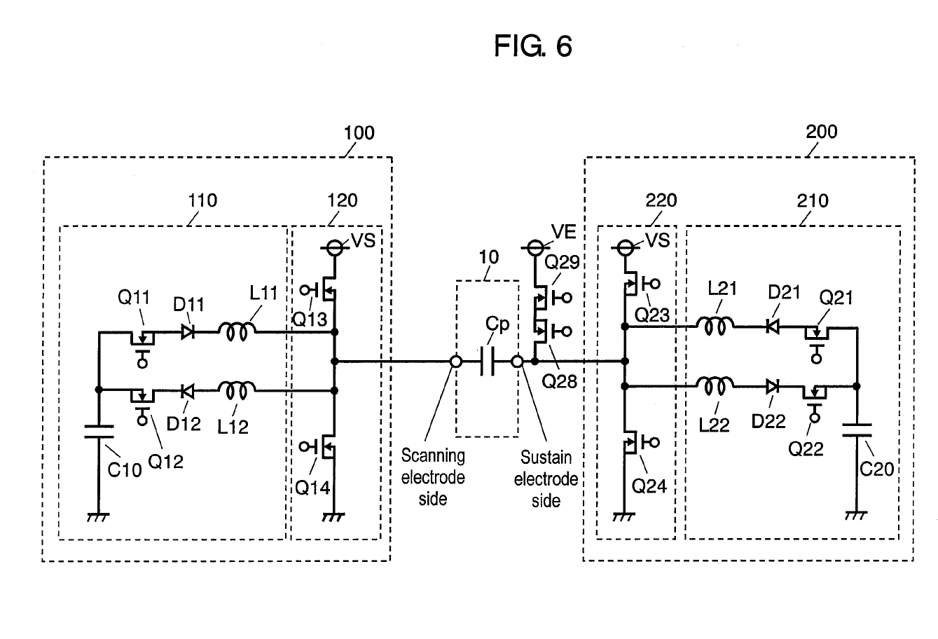

FIG. 6 is a circuit diagram of sustain pulse generating circuits 100, 200 according to the embodiment of the present invention. In FIG. 6, an inter-electrode capacity of panel 10 is indicated with Cp and the circuit for generating scanning pulse and initializing voltage waveform is omitted.

Sustain pulse generating circuit 100 has power recovering portion 110 and clamp portion 120. Power recovery portion 110 includes capacitor C10 for power recovery, switching elements Q11, Q12, reverse-current preventing diodes D11, D12 and resonance inductors L11, L12. Clamp portion 120 has switching elements Q13, Q14. Power recovery portion 110 and clamp portion 120 are connected to scanning electrode 22 which is an end of inter-electrode capacity Cp through scanning pulse generating circuit (not shown because short-circuit is generated in the sustain period). Here, inductance of inductors L11, L12 is set so that the cycle of resonance with inter-electrode capacity Cp is longer than the duration time of sustain pulse. The resonance cycle mentioned here refers to a cycle of LC resonance. Assuming that the inductance of inductor is L and the capacitance of capacitor is C, resonance cycle can be obtained according to “2π(LC)^{1/2}”. The inductance L mentioned here refers to the inductance of inductor L11 or inductor L12 and the capacitance C refers to inter-electrode capacity Cp of panel 10.

Power recovery portion 110 induces LC resonance between inter-electrode capacity Cp, inductor L11 or inductor L12 so as to raise and fall sustain pulse. When sustain pulse rises, charge accumulated in power recovery capacitor C10 is moved to inter-electrode capacity Cp through switching element Q11, diode D11 and inductor L11. When sustain pulse rises, charge accumulated in inter-electrode capacity Cp is returned to power recovering capacitor C10 through inductor L12, diode D12 and switching element Q12. Consequently, sustain pulse is applied to scanning electrode 22. Because power recovering portion 110 drives scanning electrode 22 by LC resonance without being supplied with power form a power source, ideally consumption power is 0. Capacitor C10 for power recovery has a capacity sufficiently large as compared with inter-electrode capacity Cp and is charged to about V s/2, which is half a voltage value Vs of power source VS so as to act as power source of power recovering portion 110. In the meantime, because the impedance of power recovering portion 110 is large, if a strong sustain discharge is generated when scanning electrode 22 is driven by power recovering portion 110, a voltage to be applied to scanning electrode 22 is reduced largely by the discharge current. However, in this embodiment, no sustain discharge is generated while scanning electrode 22 is driven by power recovering portion 110 or even if sustain discharge is generated, the voltage of power source VS is set to a low value so as to obtain sustain discharge to an extent that the voltage applied to scanning electrode 22 is not dropped largely.

Voltage clamp portion 120 connects scanning electrode 22 to power source VS through switching element Q13 so as to clamp scanning electrode 22 to a voltage Vs. Further, scanning electrode 22 is grounded through switching element Q14 and clamped to 0V. In this way, voltage clamping portion 120 drives scanning electrode 22. Thus, the impedance by voltage clamping portion 120 when a voltage is applied is small thereby enabling a large discharge current due to a strong sustain discharge to flow stably.

Sustain pulse generating circuit 100 applies sustain pulse to scanning electrode 22 using power recovering portion 110 and voltage clamping portion 120 by controlling switching devices Q11, Q12, Q13 and Q14. In the meantime, these switching devices can be constructed using such a generally known element as MOSFET and IGBT.

Sustain pulse generating circuit 200 includes a power recovering capacitor C20, switching elements Q21, Q22, reverse-current preventing diodes D21, D22, power recovering portion 210 having resonance inductors L21, L22, and clamping portion 220 having switching elements Q23, Q24 and is connected to sustain electrode 23 which is an end of inter-electrode capacity Cp of panel 10. An operation of sustain pulse generating circuit 200 is the same as sustain pulse generating circuit 100. The inductance of inductors L21, L22 is set so that resonance cycle with inter-electrode capacity Cp is longer than the duration time of sustain pulse of resonance cycle.

FIG. 6 shows a power source VE for generating a voltage Ve1 for relaxing a potential difference between the electrodes of the display electrode pair and switching elements Q28, Q29 for applying a voltage Ve1 to sustain electrode 23. The operations of these will be described later.

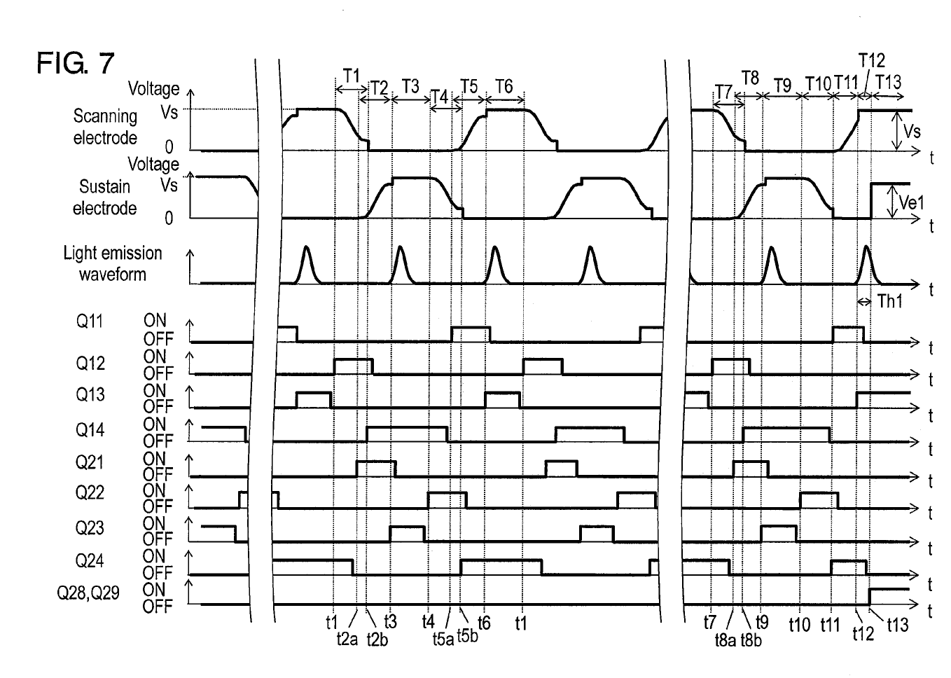

FIG. 7 is a timing chart showing operations of sustain pulse generating circuits 100, 200 according to the embodiment of the present invention. One period of the repetition period (hereinafter referred to as “sustain period”) of sustain pulse is divided to six periods indicated with T1-T6 and each period will be described. In a following description, an operation for making the switching element conductive is designated as ON and an operation for shutting it down is designated as OFF. This repetition period refers to an interval of sustain pulse applied repeatedly to display electrode pair in sustain period, for example, a period repeated in periods T1-T6. In FIG. 7, the waveform of a positive electrode will be used for description but the present invention is not restricted thereto. Although an embodiment in case of negative waveform is omitted, the same effect as in case of the negative electrode waveform can be obtained by reading an expression “rise” of the positive electrode waveform as “fall” in the negative electrode waveform.

Period T1—period T6 will be described with reference to FIG. 7.

### (Period T1)

Switching element Q1 is turned ON at time t1. Consequently, current begins to flow to capacitor C10 from scanning electrode 22 through inductor L12, diode D12 and switching device Q12, so that voltage of scanning electrode 22 begins to fall. Because in this embodiment, the period of resonance between inductor L12 and inter-electrode capacity Cp is set to 2000 ns, the voltage of scanning electrode 22 drops to substantially 0V 1000 ns after time t1. However, because period T1 from time t1 to time t2, that is, fall time of sustain pulse using power recovering portion 110 is set based on APL in a range of 650 ns-850 ns shorter than 1000 ns, the voltage of scanning electrode 22 at time t2b does not fall down to 0V. Then, switching element Q14 is turned ON at time t2b. That is, because scanning electrode 22 is grounded directly through switching element Q14, the voltage of scanning electrode 22 is clamped to 0V.

In the meantime, switching element Q24 is turned ON and sustain electrode 23 is clamped to 0V. Then, switching element Q24 which has clamped sustain electrode 23 just before time t2a is turned OFF.

### (Period T2)

Switching element Q21 is turned ON at time t2a. Consequently, current begins to flow to sustain electrode 23 from power recovering capacitor C20 through switching element Q21, diode D21 and inductor L21 so that the voltage of sustain electrode 23 begins to rise. Because the period of resonance between the inductor L21 and inter-electrode capacity Cp is set to 2000 ns, the voltage of sustain electrode 23 rises to substantially voltage Vs 1000 ns after time t2. However, because period T2 from time t2a to time t3, namely, rise time of the sustain pulse using power recovering portion 210 is set to 900 ns, the voltage of sustain electrode 23 never rise to Vs at time t3. Then, switching element Q23 is turned ON. Then, sustain electrode 23 is connected directly to power source VS through switching element Q23, so that sustain electrode 23 is clamped to voltage Vs.

In the meantime, in this embodiment, there is provided a period in which the period T1 and period T2 overlap. Hereinafter, this period, namely, a period from time t2a to time t2b is called as “overlapping period”. Time of the overlapping period is set based on APL within a range of 250 ns to 450 ns. Then, in this embodiment, the sustain period is shortened by providing with this overlapping period.

### (Period T3)

When sustain electrode 23 is clamped to voltage Vs, a voltage difference between scanning electrode 22 and sustain electrode 23 exceeds breakdown voltage at a discharge cell in which address discharge is induced, thereby generating sustain discharge. Then, switching element Q23 which clamps sustain electrode 23 to voltage Vs is turned OFF just before time t4.

In period T3, the voltage of sustain electrode 23 is maintained at sustain pulse voltage Vs and the time of period T3 is pulse duration time of sustain pulse applied to sustain electrode 23. The pulse duration time refers to a time in which the voltage of sustain pulse raised by resonance is clamped to voltage Vs and maintains voltage Vs in a predetermined time. In this embodiment, period T3 is set based on APL within a range of 850 ns to 1250 ns.

In the meantime, switching element Q12 may be turned OFF by time t5a after time t2b and switching element Q21 may be turned OFF by time t4 after time t3.

### (Period T4)

At time t4, switching element Q22 is turned ON. Consequently, current begins to flow to capacitor C20 from sustain electrode 23 through inductor L22, diode D22 and switching element Q22, so that the voltage of sustain electrode 23 begins to drop. The period of resonance between inductor L22 and inter-electrode capacity Cp is set to 2000 ns and on the other hand, period T4 from time t4 to time t5, namely, sustain pulse rise time using power recovering portion 210 is set based on APL within a range of 650 ns to 850 ns. Thus, the voltage of sustain electrode 23 is never dropped down to 0 V at time t5b.

Then, switching element Q24 is turned ON at time t5b. Consequently, sustain electrode 23 is grounded directly through switching element Q24, so that sustain electrode 23 is clamped to 0 V. In the meantime, switching element Q14 which has clamped scanning electrode 22 to 0 V is turned OFF just before time t5a.

### (Period T5)

At time t5a, switching element Q11 is turned ON. Consequently, current begins to flow from power recovering capacitor C10 to scanning electrode 22 through switching element Q11, diode D11 and inductor L11, so that the voltage of scanning electrode 22 begins to rise. While the period of resonance between inductor L11 and inter-electrode capacity Cp is set to 2000 ns, the fall time of sustain pulse using power recovering portion 110 is set to 900 ns. Thus, the voltage of scanning electrode 22 does not rise to voltage Vs at time t6. Then, at time t6, switching element Q13 is turned ON. Then, scanning electrode 22 is clamped to voltage Vs.

This embodiment is provided with a period in which period T4 and period T5 overlap and this period, namely, a period from time t5a to time t5b is called “overlapping period”. Time of this overlapping period is set based on APL within a range of 250 ns to 450 ns.

### (Period T6)

When scanning electrode 22 is clamped to voltage Vs, a voltage difference between scanning electrode 22 and sustain electrode 23 in a discharge cell in which address discharge is induced exceeds a breakdown voltage thereby generating sustain discharge.

In period T6, the voltage of scanning electrode 22 is maintained at sustain pulse voltage Vs and time of period T6 is pulse duration time of the sustain pulse applied to scanning electrode 22. In this embodiment, period T6 is set based on APL within a range of 850 ns to 1250 ns.

Switching element Q22 may be turned OFF by time t2a of next sustain period after time t5b and switching element Q11 may be turned OFF by time t1 of next sustain period after time t6. Switching element Q24 and switching element Q13 are preferred to be turned OFF just before time t2a of next sustain period and just before t1 of next sustain period respectively in order to lower the output impedance of sustain pulse generating circuits 100, 200.

By repeating the operations of periods T1-T6, sustain pulse generating circuits 100, 200 of this embodiment applies a necessary quantity of sustain pulses to scanning electrode 22 and sustain electrode 23.

As described above (in period T1 to period T6), in this embodiment, the period of resonance between inductors L11, L21 and inter-electrode capacity Cp is set to be longer than sustain time of sustain pulse, that is, periods T3, T6. Further, time which is double periods T2, T5 which are rise time of sustain pulse using power recovering portions 110, 210 is set longer than periods T3, T6. The reactive power (power consumed without contribution to light emission) of sustain pulse generating circuits 100, 200 is reduced by such a setting so as to improve emission efficiency (emission intensity to power consumption). Next, its reason will be described.

The inventors of the present invention have measured reactive power and emission efficiency by changing the resonance period of power recovering portions 110, 210 in order to search for a relationship between the resonance period of power recovering portions 110, 210, reactive power and emission efficiency. The inventors of the present invention have made experiment by setting the rise time of sustain pulse to ½ the resonance period in power recovering portions 110, 210. Thus, for example, when the resonance period of power recovering portions 110, 210 is 1200 ns, the rise time is 600 ns and when the resonance period is 1600 ns, the rise time is 800 ns.

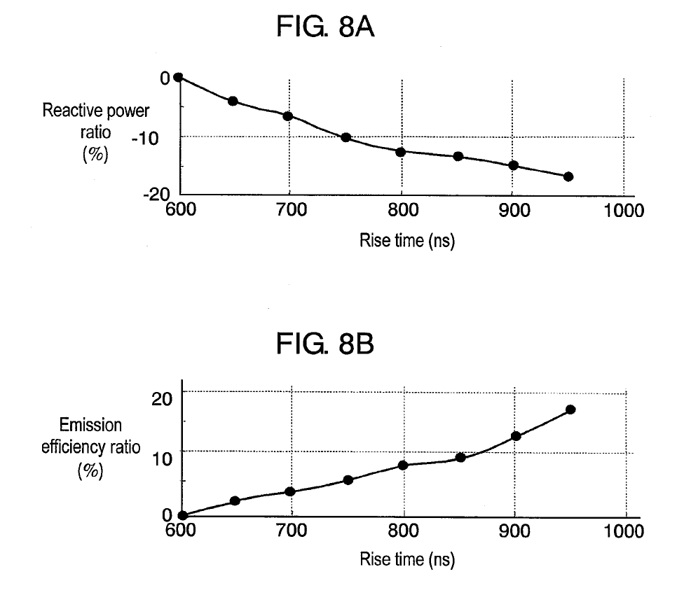

FIG. 8A is a diagram showing a relationship between the rise time of sustain pulse and reactive power of sustain pulse generating circuit of this embodiment.

FIG. 8B is a diagram showing a relationship between the rise time and emission efficiency. Both FIG. 8A and 8B indicate values calculated in percentage with the reactive power when the rise time is 600 ns as 100 and the ordinate axis of FIG. 8A indicates reactive power ratio while the ordinate axis of FIG. 8B indicates emission efficiency ratio and both the abscissa axes indicate the rise time.

From this experiment, it has been found that the reactive power of sustain pulse generating circuit 100, 200 is reduced by prolonging the rise time. As shown in FIG. 8A, if the rise time is changed from 600 ns to 750 ns, the reactive power is reduced by about 10% and if it is changed to 900 ns, the reactive power is reduced by about 15%. Further, it has been also found that when the rise time is prolonged, the emission efficiency is improved. As shown in FIG. 8B, if the rise time is changed from 600 ns to 750 ns, the emission efficiency is improved by about 5% and if it is changed to 900 ns, the emission efficiency is improved by about 13%.

If the rise of the sustain pulse is adjusted milder to 750 ns or more, preferably, 900 ns or more, it has been found that not only the reactive power of sustain pulse generating circuit 100, 200 is reduced but also the emission efficiency of the sustain discharge is improved.

If the sustain pulse duration time is too short according to the above-described drive method, the wall voltage formed with the sustain discharge becomes short, so that continuous generation of the sustain discharge is disabled. On the contrary, if the sustain pulse duration time is too long, the repetition period of the sustain pulse is prolonged, so that a necessary quantity of sustain pulse cannot be applied to the display electrode pair. For the reason, for actual purpose, it is preferable to set the sustain pulse duration time to 800 ns-1500 ns. In this embodiment, periods T3, T6 corresponding to the sustain pulse duration time are set to 850 ns-1250 ns which allows a sufficient wall voltage to be accumulated and a necessary quantity of sustain pulses to be secured.

If taking these conditions into account, it has been found that by setting a time double periods T2, T5 which are rise time of the sustain pulse using power recovering portions 110, 210 longer than periods T3, T6 which are the sustain pulse duration time, it is found that the effects of reduction of the reactive power and improvement of the emission efficiency can be obtained. More preferably, the rise time of the sustain pulse is set longer than periods T3, T6. By setting the period of resonance between inductors L11, L21 and inter-electrode capacity Cp double or more periods T2, T5 which are the rise time of the sustain pulse, it is possible to prevent a voltage applied to the display electrode pair from dropping in periods T2, T5 which are the rise time of the sustain pulse. Thus, by setting the resonance period longer than periods T3, T6 which are the duration time of the sustain pulse, the effects of reduction of the reactive power and improvement of the emission efficiency can be obtained. More preferably, a time 0.5-0.75 times the resonance period is set longer than periods T3, T6.

A sustain period from period T1 to period T6 is a period. In this embodiment, by providing an overlapping period from time t2a to time t2b in which period T1 and period T2 overlap and an overlapping period from time t5a to time t5b in which period T4 and period T5 overlap, the sustain period is reduced by an amount corresponding to that overlapping period. As a result, the drive time of a field is reduced and by using the shortened drive time, luminance magnification is increased to increase the quantity of sustain pulses thereby raising the peak luminance of displayed image.

Sustain pulse generating circuit 100, 200 of this embodiment includes inductor L11, L21 for determining the resonance period of rise of sustain pulse and inductor L12, L22 for determining the resonance period of fall of sustain pulse. Thus, to change the rise time or fall time of the sustain pulse, the value of inductors L11, L21 or inductors L12, L22 is changed so as to coincide with diversified specifications of the panel. Particularly, in case of moderating the rise of the sustain pulse by increasing the rise time, it is preferable that the resonance period of the rise of the sustain pulse and the resonance period of the fall thereof can be set each independently. Further, by constructing power recovering portion 110, 210 such that it has inductors L11, L21 and inductors L12, L22 independently, the caloric value of each inductor can be made half thereby obtaining an effect of reducing the heat resistance of the inductor.

In the above description, a difference between the rise time and fall time of the sustain pulse is not so large. Thus, the resonance period of the rise and the resonance period of the fall of the sustain pulse in power recovering portion 110, 210 are set to an identical value and inductors L11, L21 and inductors L12, L22 are provided with identical inductance.

Next, an operation for providing a potential difference which generates erase discharge from the rear half portion of the sustain period to between the electrodes of the display electrode pair will be described. Because period T7, period T8, period T9 and period T10 in FIG. 7 are the same as the above described period T1, period T2, period T3 and period T4, description thereof is omitted. Next, period T11 to period T13 will be described with reference to FIG. 7.

### (Period T11)

At time t11, switching element Q11 is turned ON. Consequently, current begins to flow from power recovering capacitor C10 to scanning electrode 22 through switching element Q11, diode D11 and inductor L11, so that the voltage of scanning electrode 22 begins to rise. In this embodiment, period T11 from time t11 to time t12, namely, a rise time of a final sustain pulse in the sustain period is set to 650 ns, shorter than 900 ns of the rise time (period T2, period T5) of other sustain pulse. Then, at time t12 before the voltage of scanning electrode 22 rises to the vicinity of Vs, switching element Q13 is turned ON. Consequently, scanning electrode 22 is connected directly to the power source VS through switching element Q13 and clamped to the voltage Vs.

### (Period T12)

When the voltage of scanning electrode 22 rises to the voltage Vs, a voltage difference between scanning electrode 22 and sustain electrode 23 exceeds breakdown voltage in a discharge cell in which sustain discharge has occurred, thereby generating sustain discharge. Then, switching element Q24 which clamps sustain electrode 23 to 0V is turned OFF just before time t13.

### (Period T13)

At time t13, switching element Q28 and switching element Q29 are turned ON. Consequently, sustain electrode 23 is connected directly to power source VE for erase through switching elements Q28, Q29, so that the voltage of sustain electrode 23 rises up to Ve1 steeply. Time t13 is a time before the sustain discharge generated in period T12 is ended, that is, in which charged particles generated by sustain discharge is left sufficiently in discharge space. Because an electric field in the discharge space is changed while the charged particles are left sufficiently in discharge space, the charged particles are rearranged to relax this changed electric field so as to form a wall charge. Because a difference between the voltage Vs applied to scanning electrode 22 and voltage Ve1 applied to sustain electrode 23 is small, the wall voltage on scanning electrode 22 and sustain electrode 23 is weakened. A time interval from time t12 to time t13, namely, period T12, is a time interval until voltage Ve1 is applied to sustain electrode 23 after voltage Vs for generating final sustain discharge is applied to scanning electrode 22. By applying this voltage Ve1 to sustain electrode 23 before final sustain discharge is ended, a potential difference between the electrodes of the display electrode pair is relaxed. A phase difference until voltage Ve1 is applied to sustain electrode 23 since voltage Vs for generating the final sustain discharge is applied to scanning electrode 22 turns into a narrow pulse shape and its pulse width is erase phase difference Th1. Thus, the sustain discharge generated finally turns to discharged which can be called erase discharge. Because data electrode 32 is maintained at 0 V and charged particles by discharge in order to relax a potential difference between a voltage applied to data electrode 32 and a voltage applied to scanning electrode 22 form a wall charge, positive wall voltage is accumulated on data electrode 32.

In this embodiment, time of period T12 having erase phase difference Th1 is set to 350 ns. Further, time of period T11, which is a rise time of final sustain pulse in the sustain period is set to 650 ns, shorter than 900 ns of periods T2, T5 which are rise time of other sustain pulses.

As described above (from period T11 to T13), the reason why erase phase difference Th1 is set to 350 ns and the rise time of final sustain pulse in the sustain period is set to 650 ns shorter than the rise time of other sustain pulses will be described.

The inventors of the present invention have made an experiment for searching for a relationship among erase phase difference Th1, the rise time at the final sustain pulse and voltage Ve1 applied to sustain electrode 23 in the initializing period. Because if voltage Ve1 applied to sustain electrode 23 is set too high, such a malfunction that discharge may occur in a discharge cell to which no write pulse is applied can be generated, lowering of this voltage is preferable for widening a drive margin.

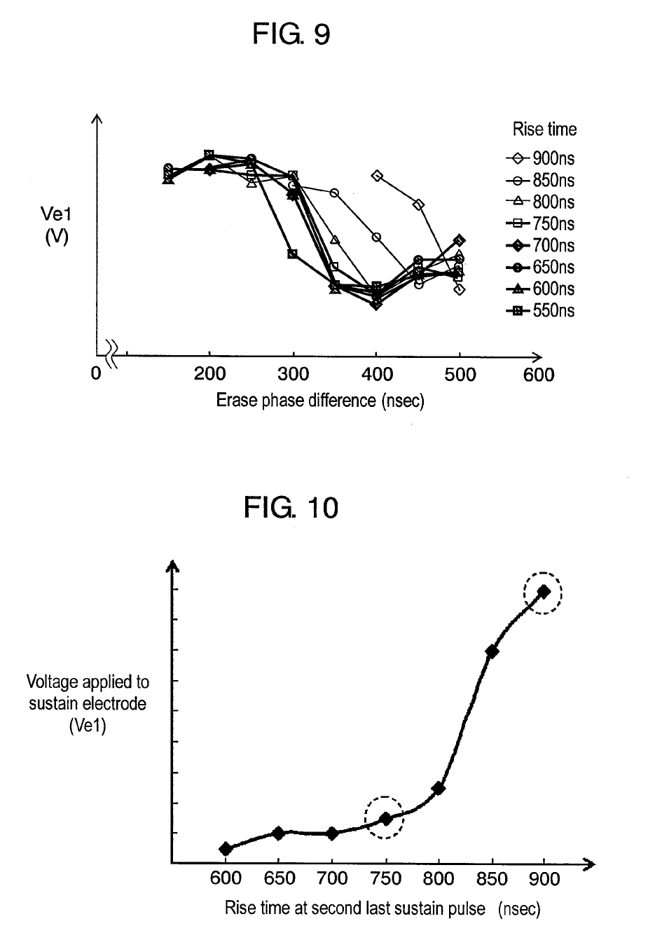

FIG. 9 is a diagram showing a relationship among a voltage Ve1 necessary for performing normal selective initializing operation in the initializing period, erase phase difference Th1 and rise time of final sustain pulse. The abscissa axis indicates erase phase difference Th and the ordinate axis indicates voltage Ve1. From a result of the experiment, it has been found that by setting the rise time in the last sustain pulse to 800 ns or less and erase phase difference Th1 to 350 ns-400 ns, voltage Ve1 necessary for performing the normal selective initializing operation can be decreased. In this embodiment, on the basis of these experiment results, erase phase difference Th1 is set to 350 ns and the rise time of the last sustain pulse is set to 650 ns. As a result, voltage Ve1 to be applied to sustain electrode is decreased to widen the drive margin at the time of write thereby achieving stable initializing discharge and address discharge.

Additionally, the inventors have found that by reducing the rise time of sustain pulse second from the last of the sustain period, that is, period T8 in FIG. 7 to be shorter than 900 ns, voltage Ve1 necessary for performing normal selective initializing operation can be decreased.

FIG. 10 is a diagram showing a relationship between the rise time of second last sustain pulse and voltage Ve1. The abscissa axis indicates a rise time of second last sustain pulse while the ordinate axis indicates voltage Ve1. From a result of the experiment, it has been found that by setting the rise time of second last sustain pulse to 800 ns or less, voltage Ve1 can be decreased. At the same time, it has been found that voltage Ve1 is not changed so much if it is set shorter. Thus, according to this embodiment, the rise time of second last sustain pulse is set to 750 ns by considering the usage efficiency of recovery power. As a result, sustain electrode applied voltage Ve1 for generating normal initializing discharge is reduced further thereby achieving further expansion of the drive margin.

Next, the inventors have made an experiment for searching for a relationship among a ratio of the quantity of discharge cells generating sustain discharge to the quantity of all discharge cells (hereinafter referred to as “lighting ratio”), sustain period and sustain pulse applied voltage necessary for generating sustain discharge (hereinafter abbreviated as “lighting voltage”).

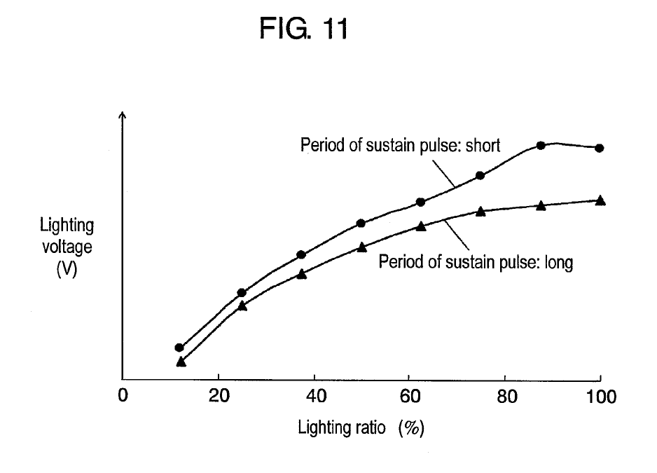

FIG. 11 is a diagram showing a relationship between the lighting ratio and lighting voltage of this embodiment. The ordinate axis indicates lighting voltage while the abscissa axis indicates lighting ratio. Sustain period is 3.8 μsec and 4.8 μsec. From this experiment, it has been found that when the lighting ratio is low, the lighting voltage drops and when the lighting ratio is high, the lighting voltage rises. Further, it has been also found that when sustain period becomes shorter, the lighting voltage rises and when sustain period is increased, the lighting voltage drops.

The reason why the lighting voltage rises as the lighting ratio is increased can be considered to be that apparent lighting voltage rises because when the lighting ratio rises, discharge current is increased so that voltage drop due to resistance component of the display electrode pair is increased thereby a voltage applied between the display electrode pair of the discharge cell rising. The reason why the lighting voltage rises when sustain period is shortened can be considered to be that when sustain period is shortened, sustain pulse duration time is also shortened, so that the wall voltage accumulated with sustain discharge is reduced, thereby sustain pulse voltage to be applied to the display electrode pair being increased by that corresponding amount.

Generally, when an image having a low APL is displayed, the lighting ratio of a subfield having a large luminance weight is low. Thus, as described above, the lighting voltage drops. This indicates that the sustain period of the subfield having a large luminance weight can be reduced when an image having a low APL is displayed.

Thus in this embodiment, when displaying an image having a low APL, a drive in which the sustain pulse duration time of a subfield having a large luminance weight is made. Additionally, in this embodiment, when displaying an image having a low APL, the period in which the rise and fall of sustain pulse overlap is prolonged while the fall time of sustain pulse is shortened so as to reduce the sustain period further. However, if the overlapping period of the sustain pulses is increased too much or the fall time of the sustain pulse is decreased too much, the reactive power is inclined to be increased. Thus, in this embodiment, by taking into account the discharge characteristic of the panel and dispersion thereof, the overlapping period of the sustain pulse is set to 250 ns-450 ns and the fall time of the sustain pulse is set to 650 ns-850 ns. Then, the luminance magnification is raised by using the reduced drive time so as to increase the quantity of the sustain pulses, thereby the peak luminance of a display image being raised.

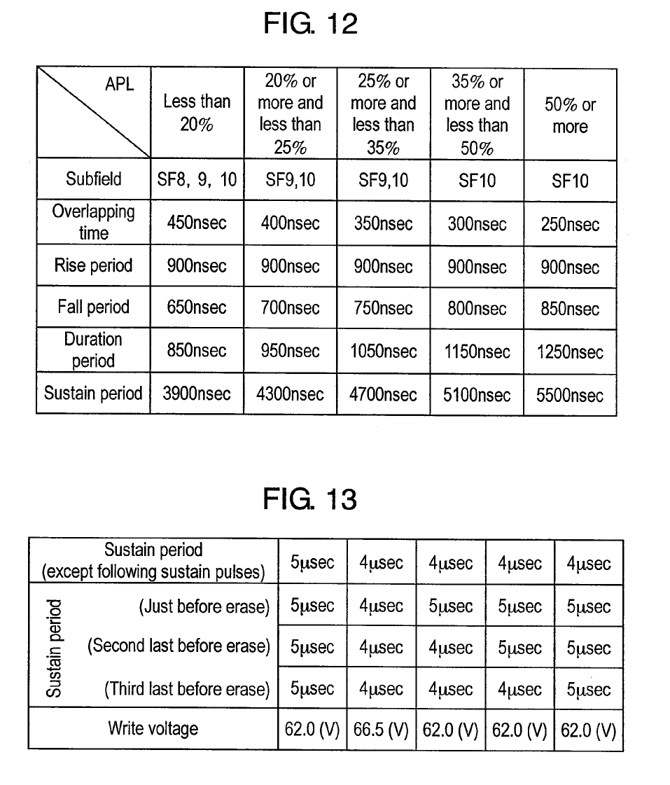

FIG. 12 is a diagram showing a relationship between the APL of the plasma display device of this embodiment and the shape of the sustain pulse. In this embodiment, when an image having less than 20% APL is displayed, the overlapping period of the sustain pulse of eighth SF—tenth SF is set to 450 ns, the fall time of the sustain pulse is set to 650 ns and the sustain period is set to 3900 ns. Further, when displaying an image having APL of 20% or more and less than 25%, the overlapping period of the sustain pulses of ninth SF and tenth SF is set to 400 ns, the fall time of the sustain pulse is set to 700 ns and the sustain period is set to 4300 ns. When displaying an image having APL of 25% or more and less than 35%, the overlapping period of the sustain pulses of ninth SF and tenth SF is set to 350 ns, the fall time of the sustain pulse is set to 750 ns and the sustain period is set to 4700 ns. When displaying an image having APL of 35% or more and less than 50%, the overlapping period of the sustain pulse of tenth SF is set to 300 ns, the fall time of the sustain pulse is set to 800 ns and the sustain period is set to 5100 ns. Then, when displaying an image having APL of 50% or more, in the tenth SF, overlapping period of the sustain pulse is set to 250 ns, the fall time of the sustain pulse is set to 850 ns, and the sustain period is set to 5500 ns. Consequently, the luminance magnification can be raised up to 4.3 times max.

In this embodiment as described above, to display an image having a low APL, the sustain period of a subfield having a large luminance weight is reduced. Then, the luminance magnification is raised by using the reduced drive time so as to increase the quantity of the sustain pulses, thereby the peak luminance of a displayed image being raised. However, the reduced drive time may be used for improvement of the display quality by increasing the number of display gradations or stabilize discharge by increasing the all-cell initializing operation.

However, it has been found that if the sustain period is simply reduced so as to reduce the sustain pulse duration time, the write pulse voltage Vd for generating address discharge securely needs to be set high. This can be considered to be because the wall voltage accumulated on top of the data electrode becomes short due to the erase discharge in period T12 of FIG. 7 so that a necessity of raising write pulse voltage Vd is generated to compensate for that shortage a the address period. As a result of consideration to reduce write voltage Vd by the inventors, it has been found that the write pulse voltage can be returned to its original state by prolonging the duration time of the sustain pulse for generating the sustain discharge just before the erase discharge, that is, period T8 of FIG. 7.

FIG. 13 is a diagram showing a result of an experiment for searching for a relationship among the sustain period, the duration time and write voltage Vd necessary for generating the address discharge securely. When the sustain period is shortened from 5 μsec to 4 μsec in this way, the write voltage rises from 62 V to 66.5 V. However, by prolonging the duration time of the sustain pulse just before erase discharge to 1000 ns so as to extend the sustain period to 5 μsec or more even if the sustain period is 4 μsec, the write voltage can be returned to 62 V. Further, it has been found that even if the duration time of a second last or third last sustain pulse is prolonged in addition to the sustain pulse just before the erase discharge, the write voltage is not reduced more. Therefore, although the duration time of the sustain pulse just before the erase discharge may be prolonged to reduce the write pulse voltage, the duration time of a second last or third last sustain pulse is permitted to be prolonged if there is an excess in the drive time.

In the meantime, sustain pulse voltage Vs needs to be so high that the sustain discharge is generated securely. However, as the operation of the power recovering portions 110, 210 has been described with reference to FIG. 6, sustain pulse voltage Vs is preferred to be set so low that the discharge current is dispersed. If voltage Vs is too high, a strong sustain discharge is generated in periods T2, T5 in which sustain pulse is applied to scanning electrode 22 or sustain electrode 23 using power recovering portions 110, 210, thereby a large discharge current flowing. Because impedance in power recovering portions 110, 210 is high, voltage drop occurs when a large discharge current flows, so that a voltage applied to scanning electrode 22 or sustain electrode 23 drops largely thereby sustain discharge being unstable. Consequently, there is generated such a risk that the image display quality may drop, for example, the light emission luminance becoming unequal within a display area.

In this embodiment, sustain pulse voltage Vs is set to 190 V. Although this voltage value itself is not a particularly low value as compared with the sustain pulse voltage of a general plasma display device, in panel 10 for use in this embodiment, xenon partial pressure is raised by 10% so as to improve the emission efficiency, so that the breakdown voltage in the display electrode pair is increased. Thus, the voltage value of sustain pulse voltage Vs is smaller than the breakdown voltage. That is, in periods T2, T5 in which a voltage is applied to the display electrode pair using power recovering portions 110, 210, no sustain discharge is generated or even if the sustain discharge is generated, a voltage applied to the display electrode pair is dropped due to a voltage drop by the discharge current, so that not so strong a sustain discharge that the sustain discharge becomes unstable occurs.

Although in this embodiment, the above-described drive having a high emission efficiency is enabled, on the contrary, a voltage value relative to the breakdown voltage of the sustain pulse voltage is set low. Thus, unless the wall voltage is accumulated by the sustain discharge securely, the wall voltage becomes short thereby causing a risk that the sustain discharge may not be generated continuously. Particularly, if the discharge characteristic of the discharge cells constituting a display screen is dispersed, the possibility that such a problem may occur tends to be high. Thus, for a sufficient wall voltage to be accumulated securely in first sustain discharge in the sustain period, the system may be so constructed that the rise time of a first sustain pulse is set shorter than the rise time of other sustain pulses.

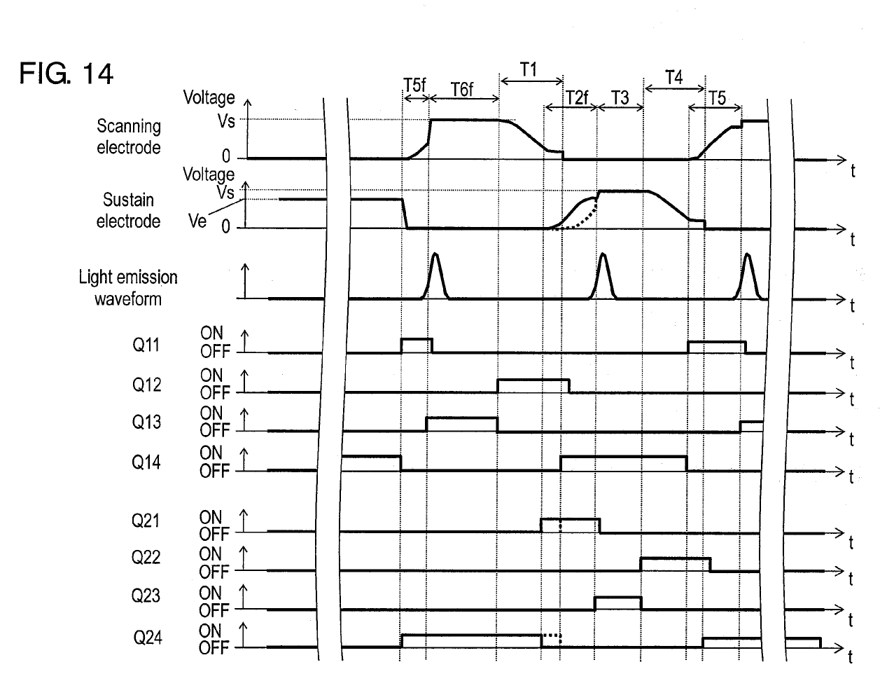

FIG. 14 is an example of a diagram of the waveform of a drive voltage applied to each electrode of the panel 10. In this example, period T5f which is a rise time of a first sustain pulse is set to 500 ns. By setting the rise time of a first sustain pulse shorter than period T5 which is a rise time of ordinary sustain pulse, a strong sustain discharge can be generated so as to secure accumulation of the wall voltage. As a result, a stable sustain discharge can be generated continuously even in a panel having a dispersion to some extent in the discharge characteristic of the discharge cell. Further, the system may be constructed so that a sustain pulse in which such a rise time is set short is inserted at an appropriate interval within a range in which power consumption is not increased largely.

Although as described above, the embodiment of the present invention has been described in conditions in which periods T2, T5 which are the rise time of the sustain pulse are set to 900 ns, the requirement here is that periods T2, T5 are less than ½ the resonance period and that a time double periods T2, T5 is longer than periods T3, T6 which are sustain pulse duration time.

Although in this embodiment, a configuration using a different inductor for each of power supply and power recovery has been described, the present invention is not restricted to this configuration but it is permissible to use the same inductor for each of power supply and power recovery.

Further, in the present invention, the voltage waveform of a last sustain pulse in a sustain period is not restricted to the above-described voltage waveform.

Although in this embodiment, the xenon partial pressure of discharge gas is 10%, other xenon partial pressure may be set to a drive voltage corresponding to a given panel.

Respective specific values for use in the embodiment are only an exemplification but it is desirable to set those values to optimal values depending on the characteristic of the panel and the specification of the plasma display.

### INDUSTRIAL APPLICABILITY

The panel drive method and plasma display device of the present invention increase the luminance of a panel and enable further reduction of power consumption, and are effective as the panel drive method and the plasma display device.

1. A drive method of a plasma display panel including a plurality of discharge cells, each discharge cell having a display electrode pair composed of a scanning electrode and a sustain electrode, and
one field being formed of a plurality of subfields, each subfield having an address period in which an address discharge is selectively generated in the discharge cell and a sustain period in which a sustain discharge is generated at the discharge cell, where the address discharge has been generated, by applying a sustain pulse by the number of times corresponding to a luminance weight, the method comprising:
detecting an average luminance level of an image signal to be displayed on the plasma display panel;
inducing a rise and fall of each sustain pulse by resonating an inter-electrode capacitor of a display electrode pair with an inductor;
clamping the voltage of the sustain pulse to a predetermined voltage; and
setting a repetition period of the sustain pulse according to the average luminance level of the image signal.

2. The drive method of a plasma display panel according to claim 1, further comprising:
shortening gradually the repetition period of the sustain pulse in a subfield having maximum luminance weight as the average luminance level of the image signal decreases.

3. The drive method of a plasma display panel according to claim 1, further comprising:
providing an overlapping period during which the rise time of the sustain pulse to be applied to one of the display electrode pair and the rise time of the sustain pulse to be applied to the other of the display electrode pair overlap each other; and
prolonging gradually the overlapping period of a subfield having maximum luminance weight as the average luminance level decreases.

4. The drive method of a plasma display panel according to claim 1, further comprising:
setting a time double the rise time of the sustain pulse to a duration time of the sustain pulse or more.

5. A plasma display device comprising:
a plasma display panel including a plurality of discharge cells, each discharge cell having a display electrode pair composed of a scanning electrode and a sustain electrode;
an average luminance level detecting circuit for detecting an average luminance level of an image signal; and
a sustain pulse generating circuit for generating sustain discharge by applying sustain pulse to each of the display electrode pair,
wherein the sustain pulse generating circuit includes a power recovering section for inducing a rise and fall of each sustain pulse by resonating an inter-electrode capacitor of a display electrode pair with an inductor and a clamp section for clamping a voltage of the sustain pulse to a predetermined voltage, and sets a repetition period of the sustain pulse according to the average luminance level of the image signal.
